(19) United States
(12) Patent Application Publication
(10) Pub. No.: US 2007/0091813 A1
(43) Pub. Date: Apr. 26, 2007

(54) AUTOMATIC CHANNEL SWITCHING METHOD FOR LOW-POWER COMMUNICATION DEVICES

(76) Inventors: GUY RICHARD, Richmond (CA); Michel Noel, Sherbrooke (CA); Sylvain Dumont, St-Elie D'Orford (CA)

Correspondence Address: GOUDREAU GAGE DUBUC, 2000 MCGILL COLLEGE, SUITE 2200, MONTREAL, QC, H3A 3H3, CA

(21) Appl. No.: 11/550,882

(22) Filed: Oct. 19, 2006

Related U.S. Application Data
(60) Provisional application No. 60/727,867, filed on Oct. 19, 2005.

(51) Int. Cl. H04J 3/14; H04J 1/16

(52) U.S. Cl. 370/248; 370/252

(57) ABSTRACT

A method allows the transmitter to change transmission to a better channel in order to minimize transfer interference. In general, the transmitter will monitor all RF channels and tag the data frames with a preferred channel ID. Upon reception of a tag within a given data frame indicating a change in preferred transmission channel, the receiver will commence listening on the new channel. To avoid transmission lapses, the transmitter may continue to transmit on the old channel for a predetermined amount of time or number of data frames to allow the receiver enough time to switch channels without losing any frames.

### CROSS-REFERENCE TO RELATED APPLICATIONS

This applications claims priority on U.S. Provisional Application No. 60/727,867 filed on Oct. 19, 2005, the entire contents of which is incorporated herein by reference.

### FIELD OF THE INVENTION

The invention relates to channel switching methods and algorithms in wireless communication systems and, more particularly, to an automatic channel switching method and algorithm for low-power wireless sensing devices in a physiological telemetry system.

### BACKGROUND OF THE INVENTION

Communication devices, and particularly low-power wireless devices expected to operate efficiently for extended periods of time on a limited power source, are generally designed to communicate using enhanced data transfer protocols and algorithms configured to reduce power consumption and thus increase the operating lifetime of the device. For wireless devices configured to communicate over various allowable communication channels within a selected bandwidth, selection of a good communication channel, that is a channel on which communications experience limited noise and interference, can make a significant difference in the device's communication efficiency and quality and, ultimately, in the device's overall power consumption.

Consequently, various protocols have been developed to implement a communication channel change when an unused or at least a partially available (e.g. channel sharing, multiplexing) communication channel is determined to provide a better data transfer efficiency and quality. These protocols are employed for various types of devices including portable phones, wireless physiological sensors, wireless computer peripherals, and the like.

For instance, the prior art teaches wireless protocols wherein, upon startup or upon detection of undue interference and/or noise, channel allocation and/or selection parameters/directives are established and communicated between a host apparatus and a slave apparatus using dedicated control messages and/or management frames. The prior art algorithms generally use a channel change synchronization method wherein a dedicated message/frame is transmitted requesting such a change to be implemented within a selected time or at the end of a predetermined period. Other prior art algorithms teach the use of a channel priority list that is updated dynamically and communicated between the host and the slave apparatus such that a highest priority channel on the list is selected and used upon validation thereof with the host apparatus. In general, acknowledgement messages and/or frames are used to confirm reception of such control/management messages/frames and to validate requested channel changes.

However, the transfer of such dedicated channel change control/management and acknowledgement messages/frames generates an undesirable consumption of energy, an important factor in low-power communication devices.

### SUMMARY OF THE INVENTION

In order to address the above and other drawbacks, there is provided a method for implementing a switch of a communication channel used for the transfer of information.

More specifically, in accordance with the present invention, there is provided an automatic channel switching method to be implemented in a transmitter, the transmitter regularly transferring data frames to a receiver via at least an active one of a plurality of wireless channels, the method comprising the steps of:
monitoring a quality of each of the channels;
selecting a best channel based on the quality;
if the best channel is other than the active channel, transferring an indicator representing the best channel to the receiver via the active channel in at least one subsequent data frame and switching the active channel in the transmitter to the best channel for transmission of future data frames thereover.

Also in accordance with the present invention, there is provided a transmitter for regularly transmitting data frames to a receiver via at least an active one of a plurality of wireless channels, the transmitter comprising circuitry adapted to monitor a quality of each of the channels to identify a best channel based on the quality and, wherein when the best channel is other than the active channel, providing an indicator representing the best channel in at least one subsequent data frame, sending the at least one subsequent data frame over the active channel and switching the active channel to the best channel for transmission of future data frames thereover.

Still in accordance with the present invention, there is provided a system for communicating data frames over at least an active one of a plurality of wireless channels, the system comprising a transmitter and a receiver, the transmitter being adapted to monitor a quality of each of the channels to identify a best channel based on the quality and, wherein when the best channel is other than the active channel, providing an indicator representing the best channel in at least one subsequent data frame, sending the at least one subsequent data frame over the active channel and switching in the transmitter the active channel to the best channel for transmission of future data frames thereover, wherein when the receiver receives the at least one subsequent data frame over the active channel, the active channel in the receiver is automatically switched to the best channel.

Other aims, objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a schematic representation of a physiological telemetry system comprising various physiologic sensors and/or sensor groups wirelessly communicating over selected communication channels with respective monitoring devices in accordance with an illustrative embodiment of the present invention;

FIG. 2 is a diagrammatic representation of an automatic wireless communication channel change algorithm implemented between the sensors and/or sensor groups and the respective sensor monitoring device of FIG. 1;

FIG. 3 is a block diagram of an illustrative protocol architecture for implementing the automatic wireless communication channel change algorithm of FIG. 2;

FIG. 4 is a diagrammatic representation of an illustrative data packet format, and its respective data frame, used to communicate data between the sensing devices and the respective monitoring devices of FIG. 1 and to implement the automatic wireless communication channel change algorithm of FIG. 2;

FIG. 5 is a flow chart illustrating a number of steps involved in the implementation of the automatic wireless communication channel change algorithm of FIG. 2; and

FIG. 6 is a diagrammatic representation of a detailed packet and frame construction in accordance with an illustrative embodiment of the present invention.

### DESCRIPTION OF ILLUSTRATIVE EMBODIMENTS

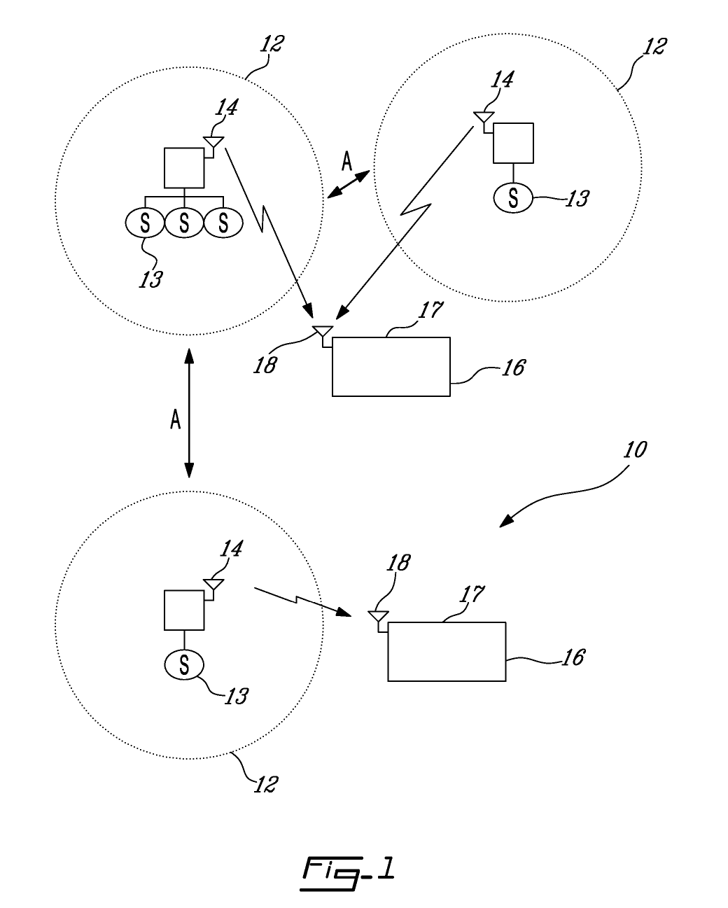

Referring to FIG. 1, and in accordance with an illustrative embodiment of the present invention, a physiological telemetry system, generally referred to using the numeral 10, will now be described. The system 10 is generally comprised of various sensing devices, as in 12, each comprising at least one sensor 13 communicatively coupled to a wireless transmitter/transceiver 14, for the wireless communication of sensed data to respective monitoring devices, as in 16.

The sensors 13 may include, but are not limited to, various types and combinations of physiological sensors such as oxymetry sensors, electrocardiogram (ECG) sensors, electroencephalogram (EEG) sensors, arterial pressure (AP) sensors, and the like. In the illustrative system 10, the sensors 13 are fitted to different patients, or again to animals in a veterinary setting, to measure and monitor various physiological parameters in order to diagnose various patient conditions and provide adequate treatment for these conditions. The monitoring devices 16, which may be locally or remotely coupled to a respective data monitor 17 and receiver/transceiver 18, receive the sensed data transmitted from the sensing devices 12 to provide various data processing, monitoring, storage and display features useful in the monitoring and treatment of patients and/or animals wearing the sensing devices 12.

It will be understood that the terms sensor(s) 13 and monitor(s) 17 are used herein to include any type of sensing and monitoring entities respectively and are not meant to be limiting in nature. For instance, the sensors 13 may comprise any type of data acquisition and sensor activation circuitry, or again comprise various sensor specific hardware and/or software for processing acquired data. Also, the monitor(s) 17 may comprise various user and/or network interfaces for storing, viewing, processing, and/or communicating received data to various local and/or remote data monitoring nodes in a medical/hospital and/or veterinary network. These, and other such system configurations should be apparent to a person of skill in the art and are thus not further addressed herein.

Still referring to FIG. 1, the sensing devices 12 are generally powered by a local energy source, such as a battery worn by the patient (not shown) of limited resources. Consequently, various methods may be employed to reduce energy consumption by the sensing devices 12 to increase battery life. In one embodiment, the sensing devices 12 may comprise a data processing circuitry, in operative combination with the sensor(s) 13, to pre-process the acquired data before transmission to a respective monitor 16 to alleviate transmission load and consequently increase battery life. Such pre-processing techniques may include, but are not limited to, various noise reduction algorithms, data compressions and the like. Alternatively, or in combination with the above data pre-processing techniques, an efficient data transmission and transmission channel management protocol may be implemented to reduce a communication of superfluous data packets and command messages to a minimum such that transmission times are reduced, leading to noticeable energy consumption economies.

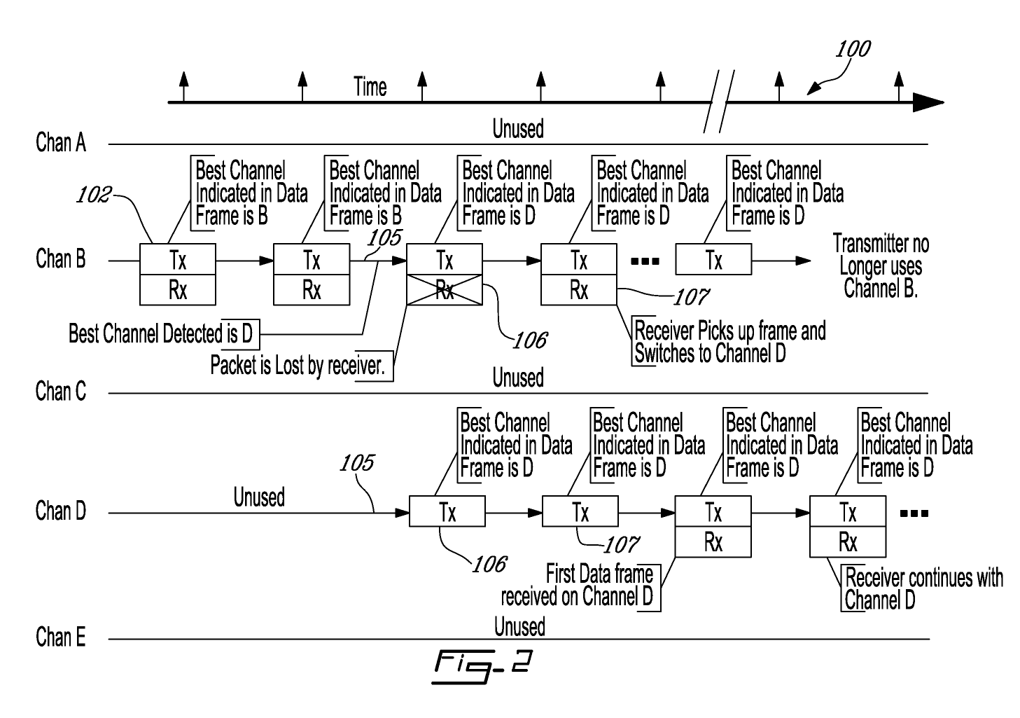

Referring now to FIGS. 1 and 2, an energy efficient automatic channel change algorithm, generally referred to using the numeral 100 and implemented in view of generally reducing energy consumption by the wireless sensing devices 12 while maintaining or increasing the reliability of the communication system 10, will be presented. A person of skill in the art will understand that though the following discussion revolves around an efficient channel change algorithm implemented between a sensing device 12 and a respective monitoring device 16 in a physiological telemetry system 10, the same algorithm may also be considered for other communication systems where energy consumption and/or transmission efficiency and reliability is of concern (e.g. general wireless, IR and optical communication systems, and the like).

Generally, the algorithm 100 is designed to allow a given sensing device 12 to communicate sensed data over a wireless communication channel determined to provide reduced interference and/or noise and thus increase the reliability and quality of the transferred data. For instance, in an environment where plural sensing devices 12 operate at one given time, possibly communicating with a same or plural monitor(s) 16 through dedicated or multiplexed communication channels, channel interference (arrows A in FIG. 1) may occur between the various devices 12 and thus reduce the quality and efficiency of data transfers. Furthermore, ambient noise and interference from surrounding devices not necessarily involved in the telemetry system 10 may also affect wireless communications over certain channels.

In the event that noise and/or interference is detected on a current transmission channel of a given sensing device 12, namely detected by a channel scanning procedure implemented by the given sensing device 12, the algorithm 100 is designed to automatically select from a list of available channels supported by the system 10, an alternative channel determined to provide better data transfer characteristics than the current channel. Data transfers using this alternative channel are then automatically initiated by the algorithm 100. To reduce energy consumption, the algorithm 100 is also designed to minimize the number of administrative commands and/or messages needed to implement such a channel change and initiate data transfers over the alternative channel.

In FIG. 2, data transmissions over five available communication channels A, B, C, D and E are illustrated as a function of time. A person of skill in the art will understand that a greater or lesser number of channels may be available for a given system at any given time and that the channel change algorithm 100 presented herein may be implemented with any number of available channels without extending the scope and general nature of the present disclosure.

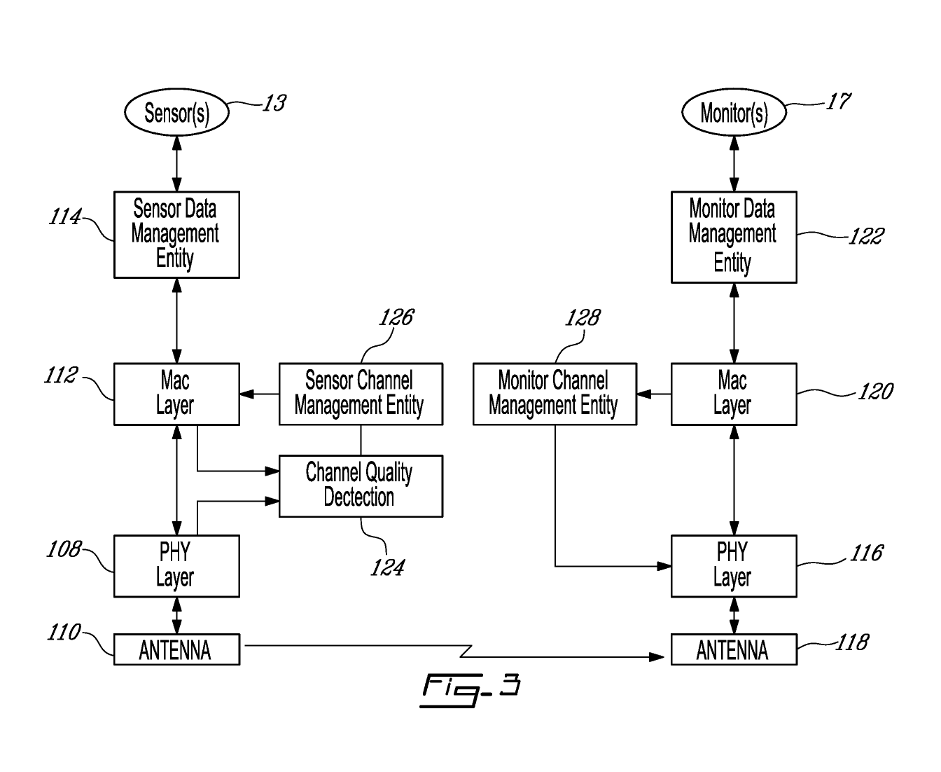

In this example, data transmissions are first executed between a given sensing device 12 and a respective monitoring device 16 using channel B. For the purpose of illustration, channel B is assumed to have been previously determined by a channel scanning procedure implemented by the sensing device 12 to provide the least amount of interference and/or noise and thus present the best channel available. Such channel scanning procedures are well known in the art and will be presented in greater detail hereinbelow with reference to FIG. 3.

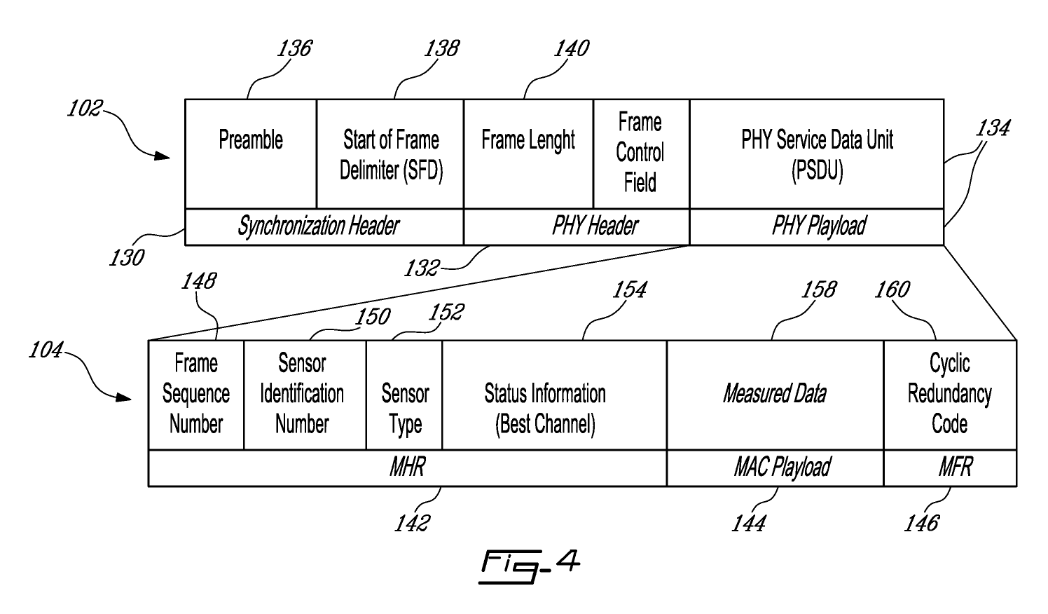

In view of the above, data packets 102 and their respective data frames (reference numeral 104 in FIG. 4), each comprising sensed data acquired by the sensor(s) 13, are transmitted periodically over channel B by the sensing device 12 and received at the monitoring device 16 configured to listen for such transmissions on the same channel B. In the data frame of each transmitted data packet 102, a Best Channel Indicator is incorporated to identify the channel B as the best available channel. Consequently, upon reception of the above data packets 102, the monitoring device 16 will extract information contained in the data frames and confirm the continuing use of channel B for future data reception, channel B being indicated by the Best Channel Indicator as the best available channel.

Meanwhile, the channel scanning procedure implemented by the sensing device 12 continuously or periodically evaluates the quality of both the current transmission channel (channel B) and other available transmission channels (e.g. channels A, C, D and E). At 105, the channel scanning procedure determines that channel D is now the best channel, possibly due to increased interference or noise on channel B. Consequently, data transmissions are initiated over channel D and data frames now comprise a Best Channel Indicator identifying channel D as the best channel. To communicate the transmission channel change to the receiving monitoring device 16, data frames are transferred over both channels B and D for a predetermined period of time, or again for a predetermined number of frames. Upon reception over channel B of a first data frame comprising a Best Channel Indicator identifying channel D as the best channel, the receiving monitoring device 16 will start listening for future transmissions over channel D and optionally cease to listen for transmissions over channel B.

In the illustrative example of FIG. 2, the first data packet 106 transmitted after the identification of channel D at 105 as being the best channel, is lost over channel B and never received by the receiving monitoring device 16. However, a subsequent packet 107 is received over channel B. Since the subsequent packet 107 comprises in its data frame a Best Channel Indicator identifying channel D as the best channel, the receiving monitoring device 16 switches to channel D for the reception of future data packets transmitted using channel D.

Upon expiry of the predetermined period of time or upon transmission of a last one of the predetermined number of frames to be sent over both the old and the new best channel, data transfers may proceed on the new best channel D until a future channel change is requested.

While the example of FIG. 2 presents an immediate switch to the new channel D at 105, it is to be understood that various delays may be established before such a switch to provide the receiving monitoring device 16 sufficient time to receive a first data frame comprising a Best Channel Indicator identifying the channel switch. For instance, a first data frame in the present example comprising a new Best Channel Indicator identifying channel D could be sent exclusively on channel B to announce the channel change to the receiving monitoring device 16. After sending this first data frame identifying channel D, data frames could be sent on both channels B and D, as illustrated in FIG. 2 and discussed hereinabove, for a predetermined number of frames or for a predetermined amount of time. This could further reduce consumption by avoiding a transfer of the first data frame identifying channel D over both channels. A person of skill in the art will understand that such permutations do not alter the general nature of the above algorithm 100 and that other such options and permutations may be considered without extending the general scope of the present disclosure.

Referring now to FIGS. 3 and 4, an exemplary data communication protocol architecture and a respective data packet and data frame construction is presented for the implementation of the above channel change algorithm 100. In the present example, the data communication protocol architecture is built from a physical (PHY) layer developed in accordance with the IEEE 802.15.4 standard, incorporated herein in its entirety by reference. This standard, optionally configured to be implemented using direct sequence spread spectrum technology (DSSS) in the 868/915 MHz or 2450 MHz ISM bands, was established in view of providing standardized base layers for efficient short range wireless communication protocols used by battery powered devices. This standard thus provides a good base in the present context for the development of an energy efficient data transfer protocol. However, to further reduce energy consumptions, a modified media access control layer (MAC) can be developed to implement the above channel change algorithm 100. A person of skill in the art will understand that the protocol architecture of FIG. 3 and the respective data packet and data frame constructions of FIG. 4 are presented as illustrative examples only to support the present disclosure. Various other protocol architectures that may or may not be built in accordance with the IEEE 802.15.4 physical layer standards, as well as other data packet and data frame structures and configurations not illustrated herein, may in fact be used in a similar manner to implement the above channel change algorithm 100 without departing from the general scope and nature of the present disclosure.

With particular reference to FIG. 3, the protocol architecture of a given sensing device 12 is generally comprised of a physical (PHY) layer 108 in operative communication with an antenna 110, a media access control (MAC) layer 112 and a sensor data management entity 114 in operative communication with the sensor(s) 13. Similarly, the protocol architecture of a given monitoring device 16 in communication with the given sensing device 12, is generally comprised of a physical (PHY) layer 116 in operative communication with an antenna 118, a media access control (MAC) layer 120, and a monitor data management entity 122 in operative communication with the monitor(s) 17.

In this example, the sensor data management entity 114 is used as an umbrella term to encompass most or all of the data acquisition control and management procedures, as well as any data management procedures and/or algorithms such as for data pre-preprocessing, data processing, data storage and the like. As presented hereinbelow, the sensor data management entity 114 may also partake in various higher level data transmission control and management procedures to complement the inner workings of the lower PHY layer 108 and MAC layer 112.

The MAC layer 112 of the sensing device 12 works cooperatively with the PHY layer 110 and the sensor data management entity 114 to, amongst other things, encapsulate data provided by the management entity 114 in proper data frames 104 to be further encapsulated into data packets 102 and transmitted by the PHY layer 108. In this illustrative embodiment, the MAC layer 112 is also responsible for implementing, in cooperation with the PHY layer 108, the channel scanning procedures discussed hereinabove through selected channel quality detection measures 124. Through a sensor channel management entity 126, illustrated here as a subcomponent of the MAC layer 112, the MAC layer 112 also manages channel priority lists and/or settings based on the results of the channel scanning procedures and implements the automatic channel change algorithm 100. A person of skill in the art will understand that at least part of the automatic channel change algorithm may also be implemented by higher levels, namely through dedicated channel quality and selection algorithms and procedures designed to select a best channel based on the results of the channel scanning procedures provided by the lower PHY layer 108 and MAC layer 112. As will be presented below with reference to FIG. 4, the MAC layer 112 is also responsible for including the Best Channel Indicator in at least some of the data frames and setting its value in accordance with the results of the channel scanning procedures and the automatic channel change algorithm 100.

The responsibilities of the PHY layer 108 comprises activating and deactivating the radio transmitter/transceiver 14, providing the hardware means of transmitting/receiving data packets 102 on a radio signal using antenna 110, and performing various tasks, in cooperation with the MAC layer 112, related to channel selection such as noise and interference detection, frequency selection, clear channel assessments and the like.

Similarly, the PHY layer 116 activates and deactivates the radio receiver/transceiver 18 and provides the hardware means of receiving/transmitting data packets 102 on a radio signal using antenna 118. Though the PHY layer 116 may also comprise the capacity to perform various channel selection related tasks, such tasks may not be useful in the implementation of the above channel change algorithm 100. These options may however still be considered to supplement the disclosed algorithm 100 without departing from the general scope and nature of the present disclosure.

The MAC layer 120 of the monitoring device 16 works cooperatively with the PHY layer 116 to extract and provide transmitted data to the monitor data management entity 122. In this illustrative embodiment, the MAC layer 120 is also responsible for implementing, in cooperation with the PHY layer 116, the channel change algorithm 100 when the monitor channel management entity 128, illustrated here as a subcomponent of the MAC layer 120, detects a channel change in the transmitted data frame. In particular, upon reception of a data frame, the MAC layer 120 will extract the value of the Best Channel Indicator therein and, if it differs from the Best Channel Indicator value of a previous data frame, the monitor channel management entity will request the PHY layer 116 to switch to the indicated channel. A person of skill in the art will again understand that at least part of the automatic channel change algorithm may also be implemented by higher layer protocols, namely through dedicated channel switching algorithms designed to interpret the value of the Best Channel Indicator and request the lower MAC layer 120 and PHY layer 116 to switch channels. Channel switching acknowledgement messages may also be generated at this level when this option is selected.

The monitor data management entity 122, also used as an umbrella term in this example to encompass a number of higher level protocols and procedures implemented by the monitoring device 16, may partake in various data processing, management, storage and display procedures, as well as participate in the transfer of raw and processed data to various networked processing, monitoring and storage devices locally or remotely communicating with the system 10. As presented hereinabove, the monitor data management entity 122 may also partake in various higher level data transmission and reception control and management procedures to complement the inner workings of the lower PHY layer 116 and MAC layer 120.

Referring now to FIGS. 3 and 4, an illustrative construction of a general data packet 102 and data frame 104 are presented. As presented hereinabove, the protocol architecture of the present system 10, as illustrated in FIG. 3, is derived in part on the IEEE 802.15.4 standard protocol architecture. Consequently, terms commonly utilized in this standard are included herein to describe general packet and frame formats for clarity only and are not meant to be restrictive of the general nature and construction of these packets and frames.

In particular, a data packet 102, illustratively generated by the PHY layer 108 of the sensing device 12 and also known as a PHY protocol data unit (PPDU), is generally comprised of a synchronizing header 130, a PHY header 132 and a PHY payload or PHY service data unit (PSDU) 134. The Synchronizing header 130 is generally comprised of a preamble 136, used to synchronize communication with the receiving PHY layer 116 of the monitoring device 16, and a start-of-frame delimiter (SFD) 138 indicating the end of the preamble 136 and the start of packet data. The PHY header 132 is generally comprised of a frame length field 140 indicating the total number of octets contained in the PSDU 134.

The PSDU 134, in this illustrative embodiment consisting of a data frame 104, is provided by the MAC layer 112 for encapsulation into the data packet 102. The data frame 104 is generally comprised of a MAC header (MHR) 142, a MAC Payload 144 and a MAC footer (MFR) 146.

The MAC header 142 generally comprises information pertaining to the type and format of data included in the frame 104 and general frame management information. In particular, the MHR 142 is illustratively comprised of a frame sequence number 148 used to sort the data once received and to identify missing frames 104, a sensor identification number 150 to identify from which sensor 13 data is provided, a sensor type field 152 (AP, EEG, ECG, oxymeter, etc.) and a status information field (best channel, low battery alarm, sensor malfunction, etc.) 154. In this example, the Best Channel Indicator is provided within the status information field 154 of the data frame by the MAC layer 112 of the sensing device 12. Upon reception and extraction of a given data frame 104, the MAC layer 120 of a receiving monitoring device 16 will evaluate the information provided by the Best Channel Indicator in the status information field 154 and proceed to switch the receiving channel to the best channel indicated therein when this best channel differs from the current receiving channel.

The MAC payload 144 generally comprises the measured data 158 but may also comprise other data and/or sensor management parameters to be used by the receiving monitoring device 16 and incorporated in the MAC payload 144 by the sensor data management entity 1 14.

Finally, the MFR 146 is generally comprised of a cyclic redundancy code (CRC) or frame check sequence (FCS) 160 to verify the integrity of the transmitted data upon reception at the receiving monitoring device 16.

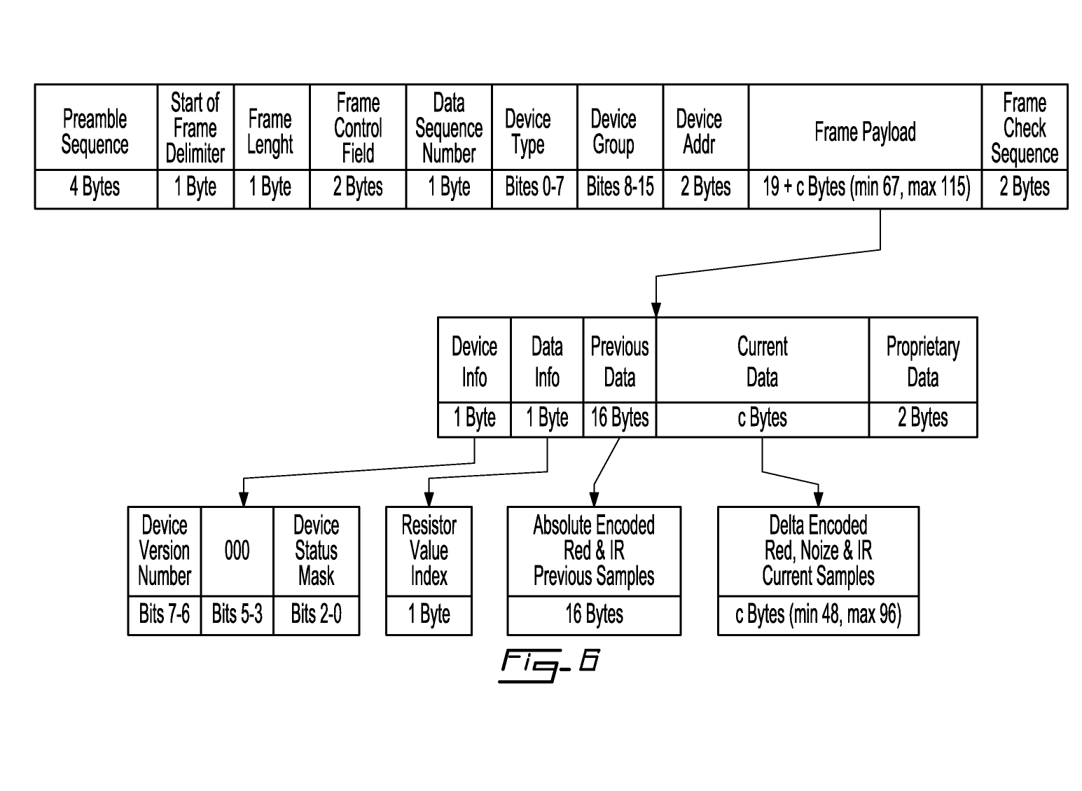

A person of skill in the art will understand that the above data packet and data frame description is only meant to provide an example of a potential packet and frame construction in the present system 10. Other packet and frame constructions and configurations may be considered without departing from the general scope and nature of the present disclosure. Namely, various fields may be added, removed, replaced and/or repositioned in the above packet and frame constructions to use the disclosed channel change algorithm 100 with other known and/or proprietary communication protocols. For example, with reference to FIG. 6, a detailed illustrative packet and frame construction is provided for communicating sensed data in a wireless oximetry system implementing the above channel change algorithm 100. Other such packet and frame constructions should be apparent to a person of skill in the art.

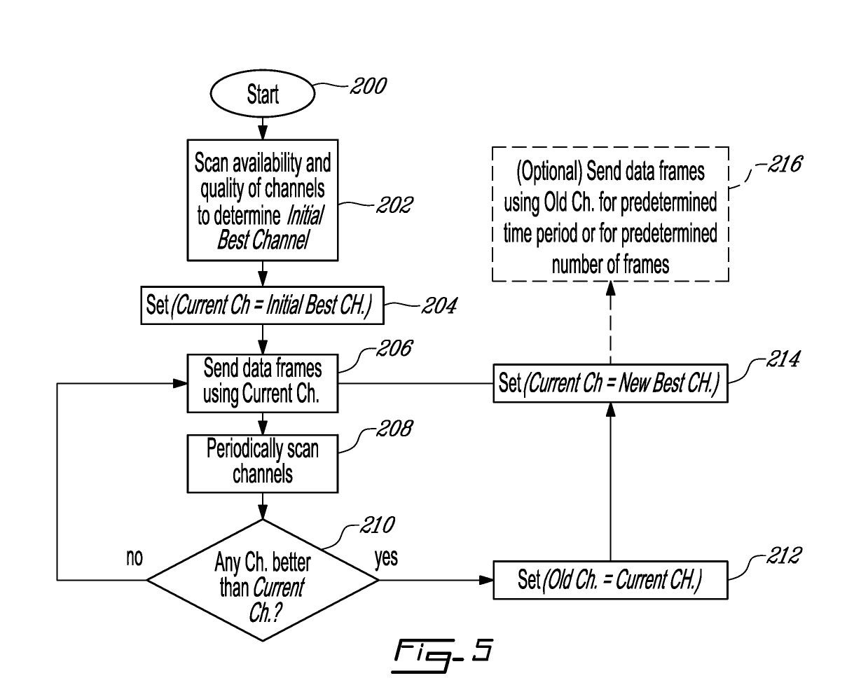

Referring now to FIGS. 2 and 5, a flow chart illustrating the steps involved in the implementation of the channel change algorithm 100 will now be presented. The algorithm illustratively starts at 200. At 202, a scan of all available channels is performed to determined which of the available channels provides the lowest amount of interference and/or noise. This channel (channel B in FIG. 2) is selected as the best channel and the current channel setting is set to the best channel (channel B) at 204. At 206, data frames are sent using the current channel (presently channel B) and the value of the Best Channel Indicator included therein is set to correspond to the current channel. At 208, the sensing device 12 periodically (or continuously depending on the settings of the sensing device 12 and the frequency of data transfers to the monitoring device 16) scans the available channels to determine at 210 weather the current channel is still the best channel.

A number of methods may be used for determining the best transmission channel, which is typically based on the channel which exhibits the least noise and/or interference. The level of noise and interference can be measured by, for example, the Received Signal Strength Indicator (RSSI) or the Link Quality Indicator (LQI). These parameters are typically measured and made available by the chipsets (not shown) which provide the RF interconnection between the sensing device 12 and the monitoring device 16.

When using the RSSI, the RF energy inside the different available RF channels is measured while the channels are inactive (that is not at that moment being used for a transmission of data). The RSSI value is proportional to the RF energy present inside the selected RF bandwidth. Noise and interference or transmission from another device will affect the measured RSSI value. A low level of RF energy indicates a possibly free channel. The channel with the lowest RSSI value is considered to be the one with the least interference and/or noise and using this approach is selected as the best transmission channel. For enhanced characterization of the RF channels, the maximum RSSI value and the averaged RSSI value over a given period of time may be computed.

As discussed above, some RF transceivers include a built-in RSSI detector that makes the measured RF energy available to the active RF channel. In some cases, a digital representation of the RSSI value can be read directly from a specific register (not shown) into the RF transceiver for use in determining the best channel for use with a subsequent transmission.

When using the LQI, the link quality is analyzed based on the quality of the received signal that has been affected during its transmission by interference and noise present in the RF channels. Quality of the link may be based on the strength of the received signal (SNR), on the cleanness of the transitions between symbols and/or on the correlation between symbols transmitted within the preamble. The channel with the best link quality is selected as the best transmission channel.

Again, as discussed above some RF transceivers measure and provide the LQI information for direct reading via registers. The LQI information can then be read and processed using a suitable algorithm, for example by selecting the best value, in order to identify the best channel available. The LQI can be evaluated either at the sensing device 13, for example by the sensing device 13 listening to its own broadcasts, or at the monitoring device 16, which could then return the LQI to the sensing device 13, for example by means of a bidirectional link between the sensing device 13 and the monitoring device 16.

If the current channel is determined at 210 to remain the best channel available, data transfers proceed over the current channel (channel B) at 206 and the Best Channel Indicator remains unchanged.

Typically, when the current channel's quality (RSSI or LQI) falls below a certain threshold, a best channel search routine is triggered. Additionally, the best channel search routine may be triggered both periodically on expiration of a delay timer of the like or manually by the user.

If the current channel (channel B) is determined at 210 not to be the best channel available, an old channel setting is set at 212 to the old current channel (channel B) and the current channel setting is set at 214 to a new best channel (channel D in FIG. 2). Data frames are then sent at 206 using the current channel, that is the new best channel (channel D), and optionally using the old channel (channel B) at 216 for a predetermined period of time or for a predetermined number of frames. From this point, the Best Channel Indicator will now identify the new best channel (channel D) weather it is sent on the current channel (channel D) or the old channel (channel B). Upon reception of these data frames, the receiving monitor 16 will read the new Best Channel Indicator and switch to the new best channel (channel D).

The algorithm 100 may proceed as such, updating when applicable the current channel value to a new best channel and the old channel value to the old current channel.

As described herein, the algorithm 100 allows the system 10 to avoid wordy dedicated channel management messages and packet transfers as channel change information is provided directly within the data packets and frames. Furthermore, acknowledgment messages need not be transferred by the monitoring device 16 and received by the sensing device 12 as a channel change is implicit in the described algorithm 100. Consequently, the data link established between a given sensing device 12 and a respective monitoring device 16 may be unidirectional without hindering the channel management, selection and switching procedures implemented by the system 10.

As such, a unidirectional link using the disclosed channel change algorithm 100 may provide a sufficiently reliable link that is comparable to a bidirectional link that uses various packet reception acknowledgement procedures. Through this enhanced reliability, energy consumptions may be greatly reduced by using a unidirectional link rather than a bidirectional link. However, if a bidirectional link is still used, energy consumptions are still reduced by the disclosed algorithm 100 by reducing the number of acknowledgement messages used in acknowledging a channel change.

However, a person of skill in the art will understand that the above algorithm 100 may be altered in various ways to increase data transfer reliability without departing from the general scope and nature of the present disclosure. For instance, various lost channel algorithms may be introduced in the event that interference on an old channel, that is a channel previously set as best channel, is such that a data frame identifying a channel change through the described Best Channel Indicator method is never received by the receiving monitoring device 16 over the old channel. After a predetermined period of time during which no packets are received from a given sensing device 12 previously communicating over the old channel, the monitoring device 16 may implement a scan channel algorithm to try and locate the new channel used by the given sensing device 12 and reestablish reception of its transmitted packets.

Alternatively, if a bidirectional link is used between the sensing device 12 and the monitoring device 16, possibly to implement various other communication and/or sensor management algorithms, a short acknowledgement message may be generated and transferred by the monitoring device 16 to acknowledge a channel change. In this alternative scenario, transmission by the sensing device 12 over the old channel may be maintained until such an acknowledgement message is received.

Also, a person of skill in the art will understand that even though the above algorithm 100 is described to include a Best Channel Indicator in each transmitted data frame, a similar channel change algorithm could only include a Best Channel Indicator in transmitted data frames when a change in communication channel is desired. Referring back to the example of FIG. 2, a Best Channel Indicator could only be included in transmitted data frames after detection of the new best channel at 105, and that, only for the predetermined amount of time or the predetermined number of frames set for transmission of frames over both the old and the new best channels. In this alternative example, absence of best channel information in the transmitted data frames informs the receiving monitoring device 16 that communications are to proceed over the channel currently in use. If however a Best Channel Indicator is included in a received data frame, the receiving monitoring device 16 will automatically switch to the new channel identified by the Best Channel Indicator. Best Channel Indicators may also be forwarded periodically, even when no channel change is requested, as a means of confirming a best channel selection by a given sensing device 12.

Although an illustrative embodiment of the invention has been described above, it should be understood that this description should not be interpreted in any limiting manner since many variations and refinements are possible without departing from the spirit of the invention. The scope of the invention will be defined in the annexed claims.

What is claimed is:

1. An automatic channel switching method to be implemented in a transmitter, the transmitter regularly transferring data frames to a receiver via at least an active one of a plurality of channels, the method comprising the steps of:
monitoring a quality of each of the channels;
selecting a best channel based on said quality;
if said best channel is other than the active channel:
transferring an indicator representing said best channel to the receiver via the active channel in at least one subsequent data frame; and
in the transmitter, switching the active channel to said best channel for transmission of future transmissions thereover.

2. The automatic channel switching method of claim 1, further comprising prior to switching the active channel to said best channel, transmitting at least one of said at least one subsequent frame of data over both said active channel and said best channel.

3. The automatic channel switching method of claim 1, wherein the transmitter and the receiver are transceivers adapted to communicate over a bidirectional link.

4. The automatic channel switching method of claim 1, wherein said monitoring step comprises measuring at the transmitter the RF energy of each of the channels and generating for each of the channels an RSSI value which is proportional to said RF energy present inside the channel and further wherein said best channel selecting step comprises selecting the channel having the lowest RSSI value.

5. The automatic channel switching method of claim 1, wherein said monitoring step comprises measuring a quality of a signal received via each of the channels and generating an LQI value for each of the channels and further wherein said best channel selecting step comprises selecting the channel having the best LQI value.

6. The automatic channel switching method of claim 5, wherein said signal quality measuring step comprises measuring a signal to noise ratio of said signal.

7. The automatic channel switching method of claim 5, wherein said signal comprises a plurality of symbols and further wherein said signal quality measuring step comprises measuring the cleanness of transitions between said symbols.

8. The automatic channel switching method of claim 5, wherein said signal comprises a plurality of symbols and further wherein said signal quality measuring step comprises measuring a correlation between said symbols.

9. A transmitter for regularly transmitting data frames to a receiver via at least an active one of a plurality of channels, the transmitter comprising circuitry adapted to monitor a quality of each of the channels to identify a best channel based on said quality and wherein when said best channel is other than the active channel, providing an indicator representing said best channel in at least one subsequent data frame, sending said at least one subsequent data frame over said active channel and switching said active channel to said best channel for transmission of future data frames thereover.

10. The transmitter of claim 9, further comprising sending, prior to switching the active channel to said best channel, at least one of said at least one subsequent data frame over both the active channel and said best channel.

11. The transmitter of claim 9, wherein the transmitter and the receiver are transceivers adapted to communicate over a bidirectional link.

12. The transmitter of claim 9, wherein said monitoring step comprises measuring at the transmitter the RF energy of each of the channels and generating for each of the channels an RSSI value which is proportional to said RF energy present inside the channel and further wherein said best channel selecting step comprises selecting the channel having the lowest RSSI value.

13. The transmitter of claim 9, wherein said monitoring step comprises measuring a quality of a signal received via each of the channels and generating an LQI value for each of the channels and further wherein said best channel selecting step comprises selecting the channel having the best LQI value.

14. The transmitter of claim 13, wherein said signal quality measuring step comprises measuring a signal to noise ratio of said signal.

15. The transmitter of claim 13, wherein said signal comprises a plurality of symbols and further wherein said signal quality measuring step comprises measuring the cleanness a transition between said symbols.

16. The transmitter of claim 13, wherein said signal comprises a plurality of symbols and further wherein said signal quality measuring step comprises measuring a correlation between said symbols.

17. A system for communicating data frames over at least an active one of a plurality of channels, the system comprising a transmitter and a receiver, said transmitter being adapted to monitor a quality of each of the channels to identify a best channel based on said quality and, wherein when said best channel is other than the active channel, providing an indicator representing said best channel in at least one subsequent data frame, sending said at least one subsequent data frame over the active channel and switching in said transmitter the active channel to said best channel for transmission of future data frames thereover, wherein when said receiver receives said at least one subsequent data frame over the active channel, the active channel in the receiver is automatically switched to said best channel.

18. The system of claim 17, wherein said transmitter and said receiver are transceivers adapted to communicate over a bidirectional link.

19. The system of claim 17, wherein said monitoring step comprises measuring at the transmitter the RF energy of each of the channels and generating for each of the channels an RSSI value which is proportional to said RF energy present inside the channel and further wherein said best channel selecting step comprises selecting the channel having the lowest RSSI value.

20. The system of claim 17, wherein said monitoring step comprises measuring a quality of a signal received via each of the channels and generating an LQI value for each of the channels and further wherein said best channel selecting step comprises selecting the channel having the best LQI value.

21. The system of claim 20, wherein said signal quality measuring step comprises measuring a signal to noise ratio of said signal.

22. The system of claim 20, wherein said signal comprises a plurality of symbols and further wherein said signal quality measuring step comprises measuring the cleanness of a transition between said symbols.

23. The system of claim 20, wherein said signal comprises a plurality of symbols and further wherein said signal quality measuring step comprises measuring a correlation between said symbols.
